(19) United States
(12) Patent Application Publication
(10) Pub. No.: US 2004/0225500 A1
(43) Pub. Date: Nov. 11, 2004

(54) Data communication through acoustic channels and compression

(76) Inventors: William Gardner, San Diego, CA (US); Ahmad Jalali, Rancho Santa Fe, CA (US); Jack Steenstra, San Diego, CA (US)

Correspondence Address: Qualcomm Incorporated, Patents Department, 5775 Morehouse Drive, San Diego, CA, 92121-1714, US

(21) Appl. No.: 10/669,475

(22) Filed: Sep. 23, 2003

Related U.S. Application Data
(60) Provisional application No. 60/413,981, filed on Sep. 25, 2002.

(51) Int. Cl. G10L 13/00

(52) U.S. Cl. 704/258

(57) ABSTRACT

Apparatus and method are disclosed for data communication using sound. Generally, an apparatus for transmitting digital data comprises a data coder configured to convert the digital data into one or more types of sound parameters, and a sound synthesizer coupled to the data coder and configured to generate sound based on the one or more types of sound parameter. An apparatus for receiving digital data comprises a sound analyzer configured to receive sound and to extract one or more types of sound parameters from the received sound, and a data decoder coupled to the sound analyzer and configured to convert the extracted one or more types of sound parameters into the digital data.

### CROSS REFERENCE TO RELATED APPLICATIONS

This Application claims the benefit of priority from co-pending U.S. Provisional Patent Application Serial No. 60/413,981 entitled “Data Communication Through Acoustic Channels And Compression” filed on Sep. 25, 2002. The disclosure of the above-identified Provisional Application is incorporated by reference herein in their entirety for all purposes.

### BACKGROUND

I. Field of Invention

The invention generally relates to data communication and more particularly, to data communication through acoustic channels.

II. Description of the Related Art

Advances in communication technology has made it easier and faster to share and/or transfer information. High volumes of data can be communicated through data transmission systems such as a local or wide area network (e.g., the Internet), a cellular network and/or a satellite communication system. These systems require complicated hardware and/or software and are typically designed for high data rates and/or long transmission ranges.

For transfers of data at close proximity, such as between a personal computer and a personal data assistant (PDA), the above systems may not provide a convenient communication medium to users. Accordingly, various communication systems have been developed using communication mediums such as radio frequency (RF) or Infrared (IR) to transmit data. However, these systems also require specialized communication hardware, which can often be expensive and/or impractical to implement. Furthermore, simple wire connections can be used to transfer data. However, to use wire connections, the users must physically have the wires and make the connections for communication. This can be burdensome and inconvenient to users.

In addition, with the increase in electronic commerce, opportunities for fraudulent activity have also increased. Misappropriated identity in the hands of wrongdoers may cause damage to innocent parties. In worst case scenarios, a wrongdoer may purloin a party's identity in order to exploit the creditworthiness and financial accounts of an individual. As a result, to prevent unauthorized persons from intercepting private information, various security and encryption schemes have been developed so that private information transmitted between parties is concealed. However, concealment of private information is only one aspect of the security needed to achieve a high level of consumer confidence in electronic commerce transactions.

Another aspect is authentication. Electronic authentication of an individual may currently be performed by authentication through knowledge, such as a password or a personal identification number (PIN); authentication through portable objects, such as a credit card, or a proximity card; and/or authentication through personal characteristics (biometrics), such as fingerprint, DNA, or a signature. However, with current reliance on electronic security measures, it is not uncommon for an individual to carry multiple authentication objects or be forced to remember multiple passwords. Authentication through knowledge can thus be problematic for individuals who are forced to remember multiple passwords and/or PINs. Writing down such information leaves an individual vulnerable to the theft of passwords or PIN codes.

Accordingly, there is need for a simple and user-friendly way to communicate and/or authenticate information at close proximity. In addition, the final destination of data may not always be at close proximity. For example, an individual may wish to send information through a telephone or a mobile phone that often involves speech compression and decompression which may significantly distort the information. Therefore, there is also a need for a way to communicate and/or authenticate information at close proximity as well as through communication networks involving speech compression/decompression.

### SUMMARY

Embodiments disclosed herein address the above stated needs by providing an apparatus and method for data communication using sound. In one aspect, an apparatus for transmitting digital data comprises a data coder configured to convert the digital data into one or more types of sound parameters, and a sound synthesizer coupled to the data coder and configured to generate sound based on the one or more types of sound parameter. An apparatus for receiving digital data comprises a sound analyzer configured to receive sound and to extract one or more types of sound parameters from the received sound, and a data decoder coupled to the sound analyzer and configured to convert the extracted one or more types of sound parameters into the digital data. Either one or both the apparatus may further comprise a storage medium configured to store one or more sets of relationships between bit patterns and one or more types of sound parameters, and wherein the data coder/decoder is configured to convert based on the one or more sets of relationships. The storage medium may comprise a look up table that predefines one or more sets of relationships.

In another aspect, a method for transmitting digital data comprises converting digital data to be transmitted into one or more types of sound parameters, and generating sound based on the one or more types of sound parameter. A method for receiving digital data comprises extracting one or more types of sound parameters from received sound, and converting the extracted one or more types of sound parameters into the digital data. Either one or both the methods may further comprise storing one or more sets of relationships between bit patterns and one or more types of sound parameters, wherein converting comprises converting based on the one or more sets of relationships. The storing may comprise storing a look up table that predefines one or more sets of relationships.

In still another aspect, an apparatus for transmitting digital data comprises means for converting digital data to be transmitted into one or more types of sound parameters, and means for generating sound based on the one or more types of sound parameter. An apparatus for receiving digital data comprises means for extracting one or more types of sound parameters from received sound, and means for converting the extracted one or more types of sound parameters into the digital data. Either one or both apparatus may further comprise means for storing one or more sets of relationships between bit patterns and one or more types of sound parameters, wherein the means for converting converts based on the one or more sets of relationships. The means for storing may store a look up table that predefines one or more sets of relationships.

In yet another aspect, a machine readable medium used for transmitting digital data comprises codes for converting digital data to be transmitted into one or more typo parameters, and codes for generating sound based on the one or more types of sound parameter. A machine readable medium used for receiving digital data comprises codes for extracting one or more types of sound parameters from received sound, and codes for converting the extracted one or more types of sound parameters into the digital data.

In a further aspect, an apparatus for transmitting and receiving digital data comprises means for converting digital data to be transmitted into one or more types of sound parameters, means for generating sound based on the one or more types of sound parameter, means for extracting one or more types of sound parameters from received sound, and means for converting the extracted one or more types of sound parameters into the digital data.

### BRIEF DESCRIPTION OF THE DRAWINGS

Various embodiments will be described in detail with reference to the following drawings in which like reference numerals refer to like elements, wherein:

FIG. 1 shows one embodiment of a device for transmitting data using sound;

FIG. 2 shows one embodiment of a device for receiving data using sound;

FIG. 3 shows one embodiment of a process for transmitting data using sound;

FIG. 4 shows one embodiment of a process for receiving data using sound;

FIG. 5A to 5C show example communications of data using sound;

FIG. 6 shows one embodiment of a system for transmitting data using sound through a wireless communication network;

FIG. 7 shows one embodiment of a process for transmitting data using sound through a wireless communication network;

FIG. 8 shows transmitting data using sound through a PSTN; and

FIG. 9 shows transmitting data using sound through an IP network.

### DETAILED DESCRIPTION

The embodiments described below allow digital data to be sent and received using sound. Generally, digital data is converted or mapped into at least one sound parameter used to synthesize sound. An artificial sound is then generated using the sound parameter(s). Therefore, the generated artificial sound encodes the digital sound and by emitting this sound, digital data is transmitted. When recovering data, relevant sound parameter(s) are extracted from received sound and the sound parameter(s) are converted back into digital data. To convert between data and parameter(s), a set of relationship is defined such that certain parameter(s) having a selected characteristic represent a predetermined pattern of binary bits.

As disclosed herein, the term “sound” refers to acoustic wave or pressure waves or vibrations traveling through gas, liquid or solid. Sound include ultrasonic, audible and infrasonic sounds. The term “audible sound” refers to sound frequencies lying within the audible spectrum, which is approximately 20 Hz to 20 kHz. The term “ultrasonic sound” refers to sound frequencies lying above the audible spectrum and the term “infrasonic sound” refers to sound frequencies lying below the audible spectrum. The term “storage medium” represents one or more devices for storing data, including read only memory (ROM), random access memory (RAM), magnetic disk storage mediums, optical storage mediums, flash memory devices and/of other machine readable mediums. The term “machine readable medium” includes, but is not limited to portable or fixed storage devices, optical storage devices, and various other devices capable of storing instruction and/or data.

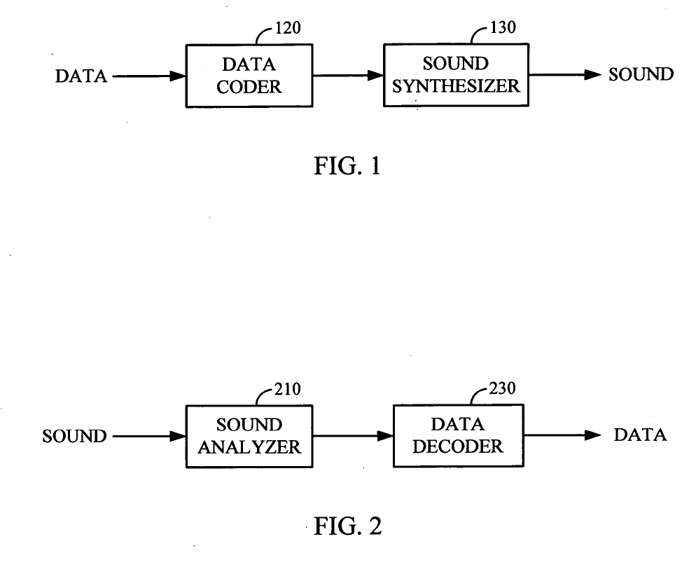

FIG. 1 shows one embodiment of a transmitting device 100 capable of sending digital data using sound and FIG. 2 shows one embodiment of a receiving device 200 capable of receiving data sent by the transmitting device 100. Transmitting device 100 comprises a data coder 120 that converts digital data to be transmitted into at least one sound parameter. A sound synthesizer 130 then generates sound based on the sound parameter(s) from data coder 120. Receiving device 200 comprises a sound analyzer 210 that extracts relevant sound parameter(s) from the received sound and a data decoder 230 that converts the parameter(s) extracted by the sound decoder 210 into digital data.

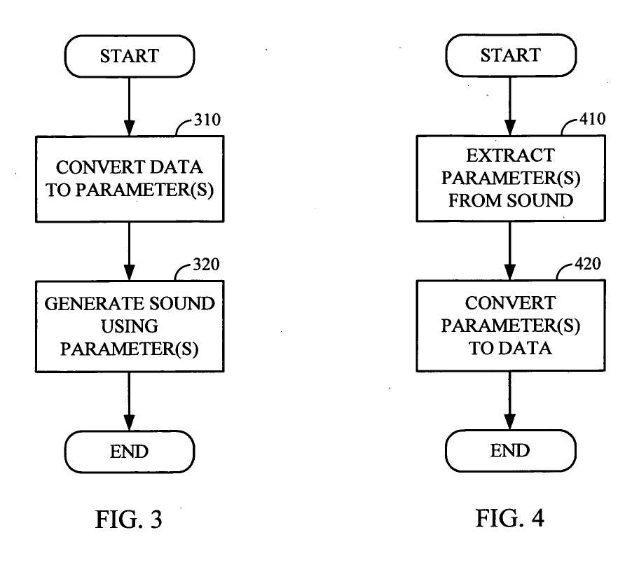

FIG. 3 shows a transmitting process 300 for sending digital data using sound and FIG. 4 shows a receiving process 400 for receiving digital data using sound. To transmit, digital data to be transmitted is converted or mapped (310) into at least one parameter that is used in synthesizing sound. Based on the sound parameter(s), sound is then generated (320) and thereby emitted. Here, data coder 120 may convert the digital data to be transmitted and sound synthesizer 120 may generate the sound. When sound is received, the sound parameter(s) are extracted (block 410) and converted back into digital data (block 420). Here, sound analyzer 210 may extract relevant parameter(s) and data decoder 230 may convert the parameter(s) into digital data.

More particularly, a set of relationship between bit patterns and at least one parameter is defined to convert the digital data into at least one sound parameter, hereinafter called data symbol. Based on the set of relationship, data coder 120 and data decoder 230 convert the data to and from parameter(s), respectively. Here, any suitable relationship may be defined for the conversion, as long as data coder 120 and date decoder 230 uses the same set of relationship. Also, data coder 120 and data decoder 230 may comprise or may be implemented as a processor (not shown) that use the set of relationship to convert between digital data and parameter(s).

In addition, transmitting device 100 and receiving device 200 may further comprise a storage medium (not shown) that stores the set of relationships. It would be apparent to those skilled in the art that the location of the storage medium does not affect the operations of transmitting device 100 and receiving device 200. Accordingly, in transmitting device 100, the storage medium may be implemented as part of data coder 120 or may be any suitable storage medium located external to data coder 120. Similarly, in receiving device 200, the storage medium may be implemented as part of data decoder 230 or may be any suitable storage medium located external to data decoder 230.

In one embodiment, one or both the transmitting device 100 and the receiving device 200 may be implemented with a look-up table (LUT) in the storage medium that predefines a relationship between parameter(s) and bit patterns. The LUT may then be used by the data coder 120 to convert received digital data into at least one parameter. Similarly, the LUT may be used by the data decoder 230 to convert the parameter(s) extracted by the sound decoder 210 into digital data.

Table 1 below is an example of a LUT for converting between digital data and one parameter, where A, B, C and/or D may be a pitch value or a range of pitch values.

| [00031] PITCH | [00032] BIT PATTERN |
|---|---|
| [00033] A | [00034] 00 |
| [00035] B | [00036] 01 |
| [00037] C | [00038] 10 |
| [00039] D | [00040] 11 |

As shown, the LUT defines a relationship between bit patterns and pitch values, which is often a parameter used in synthesizing sound. Accordingly, to transmit a digital data of “010001,” for example, the bit pattern would be converted to pitch values of “BAB” based on the LUT. The pitch values “BAB” that represent the digital data would then be used to generate sound in three consecutive frame, the pitch being constant over one frame. To receive the digital data, the pitch values “BAB” can be extracted from the received sound and converted to the bit pattern of “010001” based on the LUT.

Note that for purposes of explanation, one parameter is used in the LUT. However, any number of parameters, as allowed by the system, may be used in defining a relationship between parameters and bit patterns. Also, each parameter may be defined to have more or less than four different values that correspond to different bit patterns, wherein each value may represent one value or a range of values. For example, a pitch value of “A” in Table 1 may represent a one level of pitch or may represent pitch levels within a certain range of pitch values. Moreover, a type of parameter other than pitch may be used based on the sound synthesizer implemented in a system. Depending on the sound synthesizer, the parameter or parameters used may be for synthesizing audible sound as well as ultrasonic or infrasonic sounds.

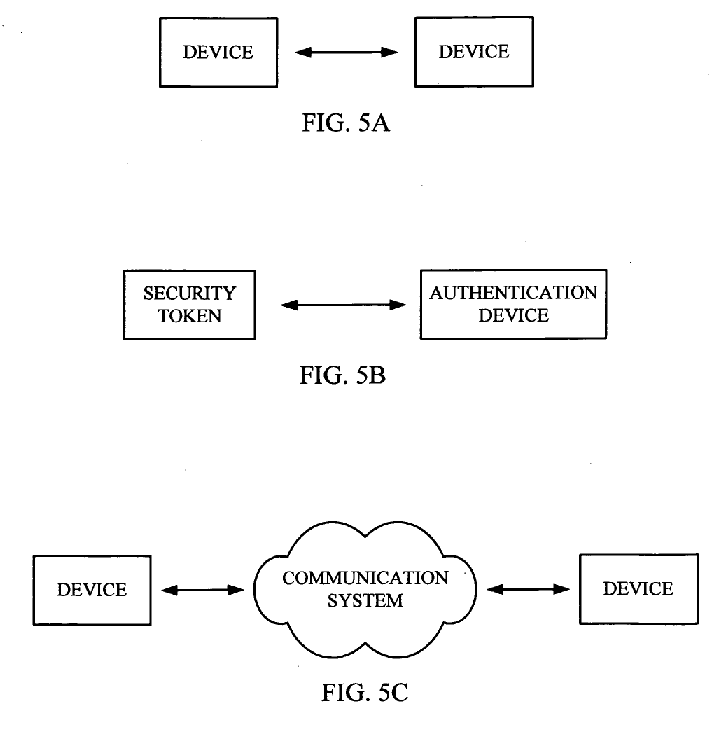

A transmitting device and/or receiving device described above may be used in various applications. As shown in FIG. 5A, sound representing data can be used to transfer, share and/or exchange information from one device to another device. The information may include, but is not limited to, personal information; contact information such as names, phone numbers, addresses; business information; calendar information; memos; software or a combination thereof. Also, some devices may be implemented with just a transmitting device, some with just a receiving device, and some with both a transmitting device and a receiving device. For example, in one embodiment of a device that implements transmitting device 100 and receiving device 200, data coder/decoder 120, 230 may be combined and/or the LUT, if implemented may also be combined. Therefore, as allowed by the implementation and depending upon the type of communication, the communication may be unidirectional or bi-directional.

In another application, a transmitting device may be a security token and a receiving device may be an authentication device, as shown in FIG. 5B. Sound representing data can be used to perform wireless authentication, wherein the data transmitted may include cryptographic signature to authenticate an individual. Cryptography is well known in the art and is generally a process of encrypting private information such that a “key” is required to decrypt the encrypted information. Authentication devices may thus be used to verify the identity of an individual to allow transaction between the individual and various external devices. Therefore, data can be sent from a security token to an authentication device to verify an individual. Note that in some authentication systems, there is a bi-directional communication between the security token and the authentication device. In such case, both the security token and the authentication device would be implemented with a transmitting device and a receiving device. When both transmitting device 100 and receiving device 200 are implemented, data coder/decoder 120, 230 may be combined and/or the LUT, if implemented may also be combined.

Additionally, while sound representing data may be directly transmitted and received, sound representing data may be transmitted and received through a communication network as shown in FIG. 5C. Here, the communication network may be one of many networks capable of transmitting sound.

In one application, sound representing data may be transmitted from one device to another through a speech coder or vocoder. Speech may be transmitted simply by sampling and digitizing at a set data rate. However, speech compression allows a significant reduction in data rate. Devices which employ techniques to compress speech by extracting parameters that relate to model of human speech generation are typically called vocoders. Such devices are generally composed of an encoder or speech synthesizer, which analyzes the incoming speech to extract the relevant parameters, and a decoder or speech synthesizer, which resynthesizes the speech using the parameters which it receives over the transmission channel. Speech is divided into blocks of time, or analysis frames, during which the parameters are calculated. The parameters are then updated for each new frame.

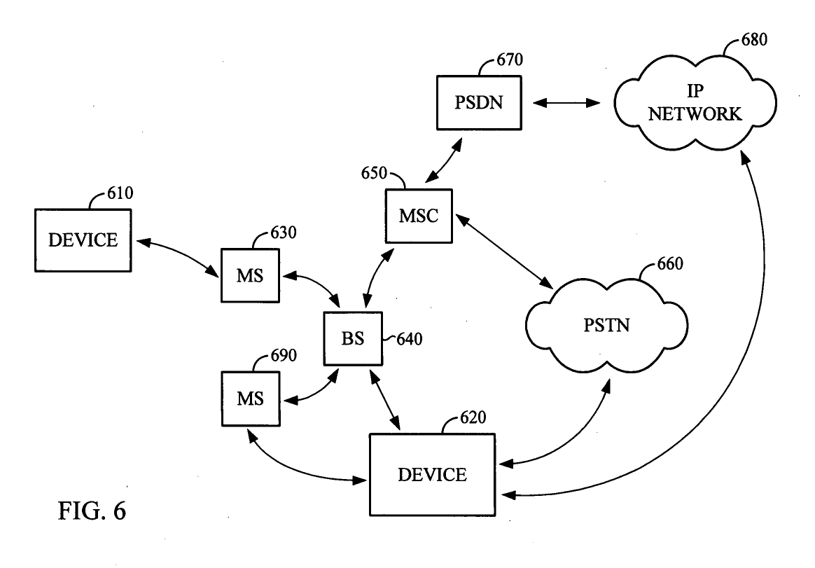

FIG. 6 shows a system 600 in which sound representing data may be transmitted from device 610 to device 620 through a vocoder. The system may comprise a wireless communication network including a plurality of mobile stations (MS) 630 and 690, also called subscriber units or remote stations or user equipment; a base station (BS) 640; and a mobile switching center (MSC) or switch 650. Depending upon the configuration, system 600 may further include a packet data serving node (PDSN) or internetworking function (IWF) 670 and an Internet Protocol (IP) network 680, and/or a public switched telephone network (PSTN) 660. It would be understood by those skilled in the art that there could be any number of transmitter devices, receiving devices, MSs, BSs, MSCs and PDSNs. Similarly, various configurations and operations of MSs 630, BS 640, MSC 650, PSTN 660, PDSN 670 and IP network 680 are well known in the art and will not be discussed.

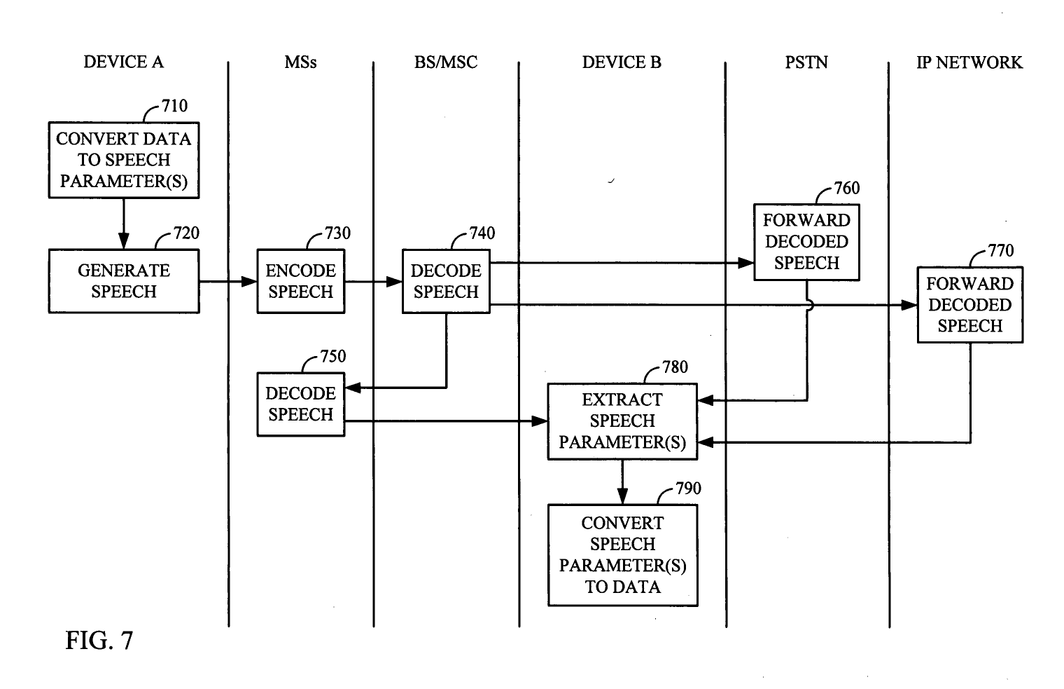

In system 600, device 610 may be implemented with, for example, transmitting device 100 and device 620 may be implemented with, for example, receiving device 200. Also, vocoder comprising both an encoder and a decoder may be implemented within mobile stations 630, 690 and base station 640. The operation of the system 600 will be described with reference to FIG. 7.

FIG. 7 shows example processes for sending data from device 610 to device 620 using sound. In FIG. 7, the data to be transmitted is converted (710) into at least one speech parameter. Using at least one speech parameter, artificial speech is then generated (720) and emitted (725) to MS 630. Here, the data may be converted or mapped, for example, by data coder 120 based on a defined set of relationships and the artificial speech may be generated by, for example, sound synthesizer 130. Also, the artificial speech is synthesized in the same manner as that of the vocoder implemented in MS 630, 690 and BS 640.

The encoder portion of the vocoder in MS 630 encodes (730) the incoming artificial speech. Namely, the incoming artificial speech is analyzed to extract the relevant speech parameter or parameters. The speech parameter(s) are transmitted (735) to base station 640. The decoder portion of the vocoder in base station 640 decodes or resynthesizes (740) speech using the received speech parameters. The resynthesized speech is sent to the appropriate destination or device 620 as controlled by MSC 650.

Depending upon the configuration of device 620, the resynthesized speech may be forwarded or sent (742) directly from BS 640 to device 620. Alternatively, the resynthesized speech may be forwarded (744) from BS 640 to device 690 through MS 690. Here, the speech parameters are sent by the BS 640, resynthesized or decoded (750) into speech by MS 690, and sent (755) to device 620. Still alternatively, the resynthesized speech may also be forwarded (746 and 748) from BS 640 to device 620 through (760) the PSTN 660 or through (770) the PSDN 670 using IP network 680.

When device 620 receives resynthesized speech, from one of MS 690, PSTN 660 or IP network 680, relevant speech parameters are extracted (780) and converted (790) back into data. Here, the relevant speech parameters may be extracted, for example, by sound analyzer 210 and the parameters may be converted, for example, by data decoder 230 using the defined set of relationship. Also, the relevant speech parameters may be extracted in the same manner as that of the vocoder implemented in the MS 630, 690 and BS 640.

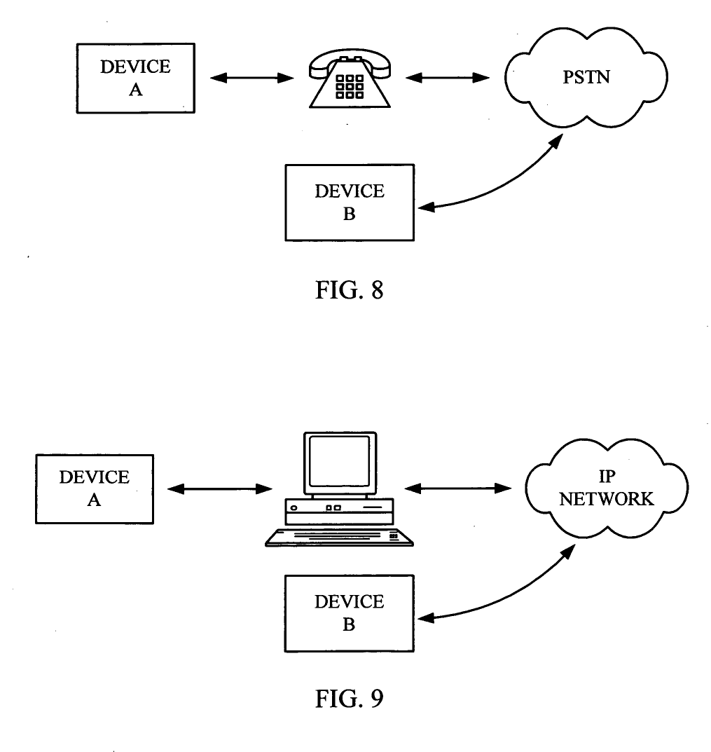

In another embodiment, artificial speech representing digital data may be sent from device A to device B directly through the PSTN 660 using a telephone, as shown in FIG. 8. Similarly, artificial speech representing digital data may be sent from device A to device B directly through the IP network 670 using, for example, a computer as shown in FIG. 9. Here, the computer may be any device capable of connecting to the IP network 670 and capable of processing sound.

Accordingly, digital data may-be sent and received as speech parameters. The types of speech parameter depend on the speech model used for resynthesizing speech in the vocoding algorithm. Vocoders often do encode voiced pitch and overall spectral shape with reasonable fidelity. Therefore, in one embodiment, pitch and/or spectral information may be used to transmit data. In addition, the overall amplitude of the waveform may also be used.

More specifically, one example of vocoding algorithm is Code Excited Linear Prediction or CELP speech model and is described in U.S. Pat. No. 5,414,796, entitled “Variable Rate Vocoder,” assigned to the assignee of the present invention. CELP or variants of CELP are often used in vocoders.

Generally, a CELP speech decoder generates resynthesized speech by generating an “excitation signal” for each frame of speech. This signal is the length of the frame and is typically close to spectrally white. The encoder specifies which excitation signal is chosen for each frame from a “codebook” of possible excitation signals. Different CELP algorithms have different structures for the excitation codebooks. These structures are typically chosen to make the process of searching through all of the possible excitation signals to find a good one as computationally simple as possible while still providing good quality reconstructed speech. The excitation signal is scaled by a gain factor, which is highly correlated with the volume of the original speech for that frame. The scaled excitation signal is passed through a “pitch filter,” which introduces long term redundancy in the speech signal. The “gain” of this filter is also dynamically varied to accommodate for varying pitch. The output of the pitch filter is then passed through a Linear Predictive Coding (LPC) filter which introduces short term redundancy in the speech signal. Therefore, the CELP encoding process typically tries to select the excitation vector, excitation gain, pitch filter parameters, and LPC filter parameters to cause the output of the decoder's LPC filter to closely match the original speech.

If the vocoder implemented in system 600 is based on CELP speech model, a relationship between bit patterns and pitch filter parameters may be defined. A relationship between bit patterns and LPC filter parameters may also be defined. Accordingly, depending upon the defined relationships, all or portions of the data to be transmitted may be converted to a pitch filter parameter, a LPC filter parameter or both.

For purposes of explanation, assume that both the pitch filter parameters and LPC filter parameters are used in defining the relationship. In such case, for example, a pitch frequency may be selected in the range of approximately 20 to 100 samples at about 8 kHz sampling rate with spacing of about 2 samples. This results in approximately 32 possibilities for the pitch frequency, thereby allowing 5 bits of information to be carried by the pitch parameter.

Also, assuming that the CELP vocoders implements LPC filters with 8 poles, for example, the locations of four (4) resonance frequencies or four (4) pairs of complex conjugate poles may be specified for mapping the digital data to LPC parameters. Typically, speech is transmitted in a narrow band of approximately 300 to 3400 Hz. If the resonance frequencies are to be spaced at approximately 250 Hz, then there are about eleven (11) positions where a pole can be placed. If 4 pairs of poles are chosen, the number of combinations of 4 pole locations in 11 positions is given by the following relationship.

$$\frac{11 !}{7 ! \times 4 !} = 330$$

This allows 8 bits of information to be carried by the LPC parameter. In a manner analogous as described above, some bits may be encoded into the gain factor. However, if the LPC filter pole locations and pitch frequency are used as in the above example, the resultant codeword would be of length 8+5=13 bits per vocoder frame.

Vocoder frames of commercial systems are typically about 10 to 20 msec long. In such case, data may be encoded into speech parameters with frames of approximately 20 msec long, hereinafter called “data frame,” to cover the range of vocoder frame sizes. However, devices 610, 620 may not be synchronized with the framing of the vocoder in MS 630, 690. Therefore, a larger frame size may be chosen in order to at least partially overlap a vocoder speech frame. For example, a 40 msec data frame may be implemented for devices 610, 620. If so, at least 20 msec consecutive samples will be encoded by at least one vocoder frame. At the receiver, the 20 msec window that provides the largest overlap between the vocoder frames and the data frames would be identified.

Note that at the beginning of a digital data transmission, a synchronization preamble will be transmitted to indicate that digital data is being transmitted. When received by the receiver, the synchronization preamble allows the receiver to detect the beginning of the digital data transmission. Accordingly, once the preamble signal is detected, the location of the largest overlap between the data and vocoder frames may be detected. This information may be used in future frames to estimate the best window of samples to use for decoding the data frame.

Also, some of the bits carried in a data frame may be used as redundancy to provide protection against errors in detecting the pitch and/or LPC resonance frequencies. If pitch and LPC resonance frequencies are used for encoding, then the pitch/resonance frequency values provide a two dimensional symbol space, herein referred to as “data symbols.” The user data is first encoded using an error correction code such as a convolutional code. The encoded bit sequence is then interleaved. The coded and interleaved bit sequence is divided into groups of n bits, and each n bit group is mapped onto a data symbol. In the example above, a group of 13 bits (5 from pitch value and 8 from the LPC resonance frequencies) are mapped onto a data symbol.

More particularly, a number of different methods may be used to convert and/or map the encoded bits onto data symbols. For example, Trellis codes may be used. Alternatively, Gray mapping may be used to map the encoded bits onto data symbols. Trellis codes are described in “Trellis-coded modulation with redundant signal set—part I: Introduction,” IEEE Communications Magazine, vol. 25, no., 2, Feb. 1987 and in “Trellis-coded modulation with redundant signal set—part II: State of the art,” IEEE Communications Magazine, vol. 25, no., 2, Feb. 1987, both by G. Ungerboeck. Gray mapping is described in

Digital Communications, by J. Proakis, 1995, McGraw Hill.

The amount of data that can be transmitted per speech frame depends on a variety of factors such as the frame size and/or the number of bits that represent a speech parameter. For example, if P bits represent the pitch filter parameters, a bit pattern of P bits or less than P bits may be defined to correspond to a pitch filter parameter.

In the description above, specific details are given to provide a thorough understanding of the invention. However, it will be understood by one of ordinary skill in the art that the invention may be practiced without these specific detail. Also, various aspects, features and embodiments of the data communication system may be described as a process that can be depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, function, procedure, software, subroutine, subprogram, etc. When a process corresponds to a function, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a storage medium. A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Accordingly, the foregoing embodiments are merely examples and are not to be construed as limiting the invention. The present teachings can be readily applied to other types of apparatuses. The description of the invention is intended to be illustrative, and not to limit the scope of the claims. Many alternatives, modifications, and variations will be apparent to those skilled in the art.

1. Apparatus for use in transmitting digital data through an audio channel that may involve a lossy speech or audio compression algorithm, the apparatus comprising:
a data coder configured to convert the digital data into one or more types of sound parameters; and
a sound synthesizer coupled to the data coder and configured to generate sound based on the one or more types of sound parameter.

2. The apparatus of claim 1, further comprising:
a storage medium configured to store one or more sets of relationships between bit patterns and one or more types of sound parameters; and
wherein the data coder is configured to convert the digital data into the one or more types of sound parameters based on the one or more sets of relationships.

3. The apparatus of claim 2, wherein the storage medium comprises a look up table that predefines one or more sets of relationships.

4. The apparatus of claim 1, wherein a sound parameter represents one value or a range of values.

5. The apparatus of claim 1, wherein the one or more sound parameters comprises a speech parameter.

6. Apparatus for use in receiving digital data through an audio channel that may involve a lossy speech or audio compression algorithm, the apparatus comprising:
a sound analyzer configured to receive sound and to extract one or more types of sound parameters from the received sound; and
a data decoder coupled to the sound analyzer and configured to convert the extracted one or more types of sound parameters into the digital data.

7. The apparatus of claim 6, further comprising:
a storage medium configured to store one or more sets of relationships between bit patterns and one or more types of sound parameters; and
wherein the data decoder is configured to convert the extracted one or more types of sound parameters into the digital data based on the one or more sets of relationships.

8. The apparatus of claim 7, wherein the storage medium comprises a look up table that predefines one or more sets of relationships.

9. The apparatus of claim 6, wherein a sound parameter represents one value or a range of values.

10. The apparatus of claim 6, wherein the extracted one or more sound parameters comprise a speech parameter.

11. A method for use in transmitting digital data through an audio channel that may involve a lossy speech or audio compression algorithm, the method comprising:
converting digital data to be transmitted into one or more types of sound parameters; and
generating sound based on the one or more types of sound parameter.

12. The method of claim 11, further comprising:
storing one or more sets of relationships between bit patterns and one or more types of sound parameters; and
wherein converting digital data to be transmitted comprises converting the digital data into the one or more types of sound parameters based on the one or more sets of relationships.

13. The method of claim 12, wherein storing the one or more sets of relationships comprises storing a look up table that predefines one or more sets of relationships.

14. The method of claim 11, wherein a sound parameter represents one value or a range of values.

15. The method of claim 11, wherein the one or more sound parameters comprises a speech parameter.

16. A method for use in receiving digital data through an audio channel that may involve a lossy speech or audio compression algorithm, the method comprising:
extracting one or more types of sound parameters from received sound; and
converting the extracted one or more types of sound parameters into the digital data.

17. The method of claim 16, further comprising:
storing one or more sets of relationships between bit patterns and one or more types of sound parameters; and
wherein converting the extracted one or more types of sound parameters comprises converting the extracted one or more types of sound parameters into the digital data based on the one or more sets of relationships.

18. The method of claim 17, wherein storing the one or more sets of relationships comprises storing a look up table that predefines one or more sets of relationships.

19. The method of claim 16, wherein a sound parameter represents one value or a range of values.

20. The method of claim 16, wherein the extracted one or more sound parameters comprise a speech parameter.

21. Apparatus for use in transmitting digital data through an audio channel that may involve a lossy speech or audio compression algorithm, the apparatus comprising:
means for converting digital data to be transmitted into one or more types of sound parameters; and
means for generating sound based on the one or more types of sound parameter.

22. The apparatus of claim 21, further comprising:
means for storing one or more sets of relationships between bit patterns and one or more types of sound parameters; and
wherein the means for converting converts the digital data into the one or more types of sound parameters based on the one or more sets of relationships.

23. The apparatus of claim 22, wherein the means for storing stores a look up table that predefines one or more sets of relationships.

24. Apparatus for use in receiving digital data through an audio channel that may involve a lossy speech or audio compression algorithm, the apparatus comprising:
means for extracting one or more types of sound parameters from received sound; and
means for converting the extracted one or more types of sound parameters into the digital data.

25. The apparatus of claim 24, further comprising:
means for storing one or more sets of relationships between bit patterns and one or more types of sound parameters; and
wherein the means for converting converts the extracted one or more types of sound parameters into the digital data based on the one or more sets of relationships.

26. The apparatus of claim 25, wherein the means for storing stores a look up table that predefines one or more sets of relationships.

27. Machine readable medium used for transmitting digital data through an audio channel that may involve a lossy speech or audio compression algorithm, the machine readable medium comprising:
codes for converting digital data to be transmitted into one or more types of sound parameters; and
codes for generating sound based on the one or more types of sound parameter.

28. The medium of claim 27, further comprising:
one or more sets of relationships between bit patterns and one or more types of sound parameters; and
wherein the codes for converting converts the digital data into the one or more types of sound parameters based on the one or more sets of relationships.

29. Machine readable medium used for receiving digital data through an audio channel that may involve a lossy speech or audio compression algorithm, the machine readable medium comprising:
codes for extracting one or more types of sound parameters from received sound; and
codes for converting the extracted one or more types of sound parameters into the digital data.

30. The medium of claim 29, further comprising:
one or more sets of relationships between bit patterns and one or more types of sound parameters; and
wherein the codes for converting converts the extracted one or more types of sound parameters into the digital data based on the one or more sets of relationships.

31. Apparatus for use in transmitting and receiving digital data through an audio channel that may involve a lossy speech or audio compression algorithm, the apparatus comprising:
means for converting digital data to be transmitted into one or more types of sound parameters;
means for generating sound based on the one or more types of sound parameter;
means for extracting one or more types of sound parameters from received sound; and
means for converting the extracted one or more types of sound parameters into the digital data.

32. The apparatus of claim 31, further comprising:
means for storing one or more sets of relationships between bit patterns and one or more types of sound parameters; and
wherein the means for converting converts the digital data into the one or more types of sound parameters based on the one or more sets of relationships, and wherein the means for converting converts the extracted one or more types of sound parameters into the digital data based on the one or more sets of relationships.

33. The apparatus of claim 32, wherein the means for storing stores a look up table that predefines one or more sets of relationships.
